(19) United States
(12) Patent Application Publication
(10) Pub. No.: US 2009/0239571 A1
(43) Pub. Date: Sep. 24, 2009

(54) MOBILE COMMUNICATION APPARATUS

(75) Inventor: Kazuhiro MOMOTA, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/206,292

(22) Filed: Sep. 8, 2008

(30) Foreign Application Priority Data
Mar. 24, 2008 (JP) P2008-076333

(51) Int. Cl. H04M 1/00

(52) U.S. Cl. 455/550.1

(57) ABSTRACT

According to one aspect of the invention, a mobile communication apparatus includes: a remote lock function configured to lock the apparatus when receiving certain information; a determining section configured to determine whether the apparatus is in a coverage area or not; and a no-service lock function configured to lock the apparatus when the determining section determines that the apparatus is out of service.

The entire disclosure of Japanese Patent Application No. 2008-076333 filed on Mar. 24, 2008 including specification, claims, drawings and abstract is incorporated herein by reference in its entirety.

### BACKGROUND

1. Field of the Invention

One embodiment of the invention relates to a mobile communication apparatus capable of locking personal information and an IC card function in no-service based on user's setting.

2. Description of the Related Art

Each company for a mobile phone gives a service for locking personal information stored in the mobile phone and a non-contact IC card function equipped for the mobile phone by a remote control when a user loses the mobile phone. Moreover, when the user loses the mobile phone, a function for locking the mobile phone based on an incoming call from a specific telephone is also used.

For example, JP-A-2007-318363 has described a communication apparatus having a structure in which a user can easily find the communication apparatus and other person can easily pick up the communication apparatus with a security maintained also in the case where the communication apparatus is lost. The communication apparatus includes a wireless communication portion that carries out a communication with other apparatus, a remote lock portion that limits a function possessed by the communication apparatus, and an automatic incoming portion that carries out a control to start a call if an incoming call in the wireless communication portion is coincident with a predetermined condition. The remote lock portion serves to operate the automatic incoming portion when limiting the function possessed by the communication apparatus.

In a method for locking a mobile phone through a communication, locking cannot be performed because communication cannot be carried out when a communication is out of service. In order to prevent an unauthorized utilization or a leakage of information by a finder while the mobile phone is lost, lock functions which can also be set in any time (in and out of coverage area) are used. The lock functions include an access restriction based on a locking number or a password, a lock function through another auxiliary device and biometrics (a fingerprint authentication, a face authentication, a voice authentication and a handwriting authentication), and so on.

In the case in which the locking number or the password is used, however, there is a danger that unlocking might be carried out due to a random input or spoofing. In addition, it is necessary to input the locking number or the password every time in unlocking. Therefore, user's feeling of use or user-friendliness may get worse. Moreover, in the case in which an auxiliary device is used or biometrics is carried out, there may be problems that a cost is increased due to an addition of hardware, a size of an apparatus is increased due to an addition of components, the user's feeling of use gets worse, and locking itself cannot be carried out due to the getting worse of the user's feeling of use.

### SUMMARY

According to one aspect of the invention, a mobile communication apparatus includes: a remote lock function configured to lock the apparatus when receiving certain information; a determining section configured to determine whether the apparatus is in a coverage area or not; and a no-service lock function configured to lock the apparatus when the determining section determines that the apparatus is out of service.

### BRIEF DESCRIPTION OF THE DRAWINGS

Embodiment may be described in detail with reference to the accompanying drawings, in which:

FIG. 1 is an exemplary view for explaining a lock function in a mobile communication apparatus (a mobile phone) according to an embodiment;

FIG. 2A is an exemplary front view showing a state in which the mobile communication apparatus (the mobile phone) according to the embodiment is opened;

FIG. 2B is an exemplary side view showing a state in which the mobile communication apparatus (the mobile phone) according to the embodiment is opened;

FIG. 3A is an exemplary front view showing a state in which the mobile communication apparatus (the mobile phone) according to the embodiment is closed;

FIG. 3B is an exemplary side view showing a state in which the mobile communication apparatus (the mobile phone) according to the embodiment is closed;

FIG. 4 is an exemplary functional block diagram showing the mobile communication apparatus (the mobile phone) according to the embodiment;

FIG. 5 is an exemplary diagram showing a data structure indicating no-service lock setting information;

FIG. 6 is an exemplary flowchart showing a procedure for executing a setting processing of a no-service lock function in the mobile communication apparatus according to the embodiment; and

FIG. 7 is an exemplary flowchart showing a procedure for executing a no-service lock processing in the mobile communication apparatus according to the embodiment.

### DETAILED DESCRIPTION OF THE EMBODIMENTS

An embodiment of a mobile communication apparatus according to the invention will be described with reference to the accompanying drawings. The description will be given by taking a mobile phone 1 of a clamshell type in which a plurality of casings is openably coupled to each other as an example of the mobile communication apparatus according to the invention.

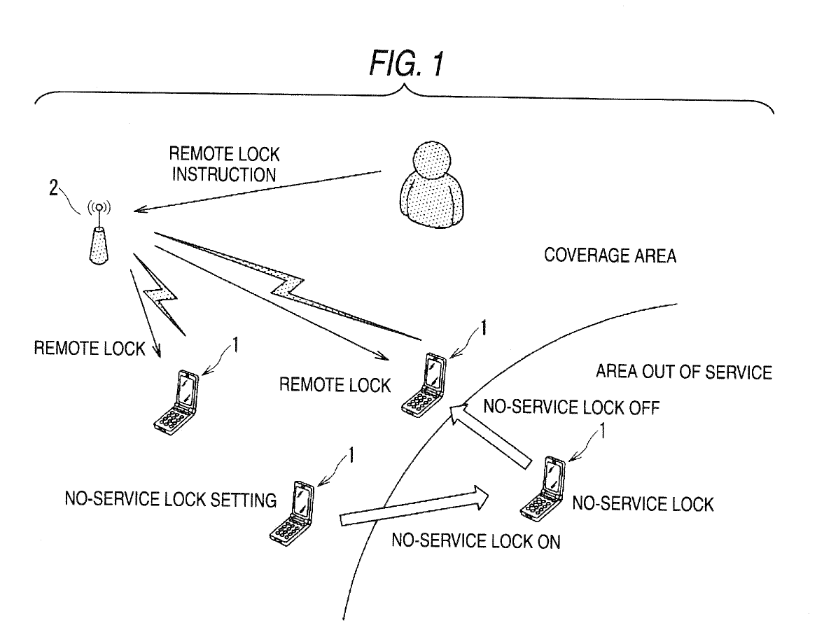

FIG. 1 is an exemplary view for explaining a lock function of the mobile phone 1. A company for the mobile phone 1 gives a service for locking personal information stored in the mobile phone 1 and a non-contact IC card function equipped with the mobile phone 1 by a remote control when a user loses the mobile phone 1. When a request for remotely locking the mobile phone is given to the company in the case in which the user loses the mobile phone, accordingly, the company transmits a signal for remotely locking the mobile phone 1 through a base station 2 to remotely lock the mobile phone 1 so that access to the personal information and use of the non-contact IC card function in the mobile phone 1 are prohibited.

However, the remote lock cannot be carried out by a communication through the base station 2 when the mobile phone 1 is out of service. For this reason, there is a problem in that the company cannot remotely lock the mobile phone 1 even if the remote lock request is given from the user.

Therefore, the mobile phone 1 has a no-service lock function for prohibiting access to internal information and use of each function when the mobile phone 1 is out of service. The no-service lock function serves to lock the mobile phone 1, thereby prohibiting the access to internal information and the use of each function based on a movement of the mobile phone 1 to an area of no-service and to unlock the no-service lock based on a return of the mobile phone 1 to a coverage area.

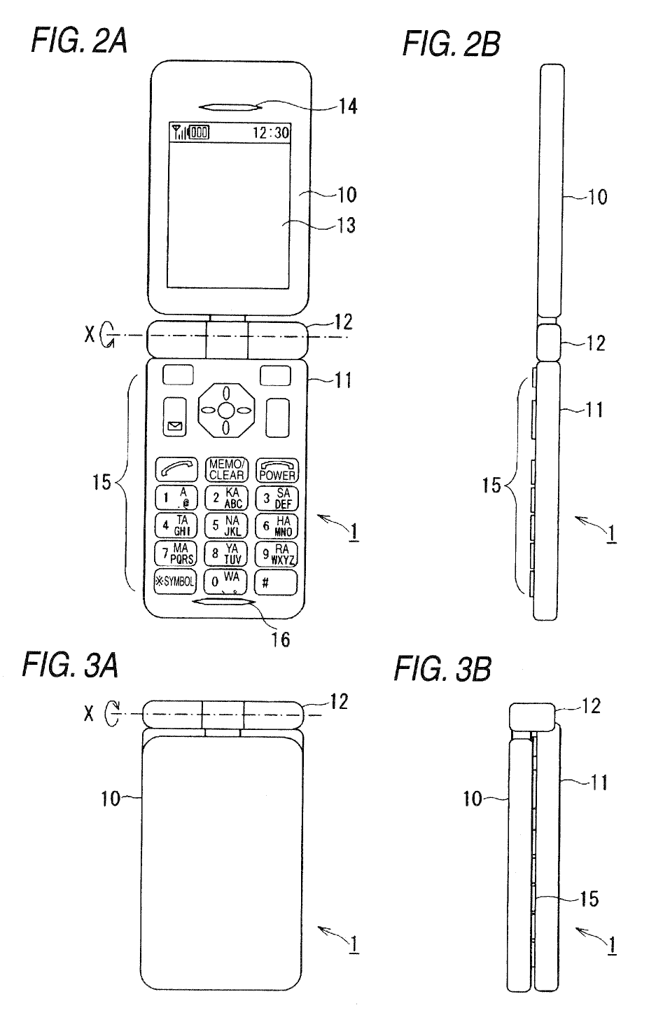

Description will be given to a structure of the mobile phone 1. FIG. 2A is an exemplary front view showing a state in which the mobile phone 1 is opened and FIG. 2B is an exemplary side view showing a state in which the mobile phone 1 is opened. Moreover, FIG. 3A is an exemplary front view showing a state in which the mobile phone 1 is closed and FIG. 3B is an exemplary side view showing a state in which the mobile phone 1 is closed.

As shown in FIGS. 2A, 2B, 3A and 3E, the mobile phone 1 is formed by stacking an upper casing 10 having a shape of a rectangular plate and a lower casing 11 having almost the same shape as the upper casing 10 to mutually cover a whole face. The upper casing 10 and the lower casing 11 are coupled to interpose a hinge portion 12 therebetween, and the upper casing 10 is formed rotatably by a predetermined angle in an X direction shown in FIG. 2A by setting the hinge portion 12 to be an axis with respect to the lower casing 11. The mobile phone 1 is deformed from a closing state to an opening state or from the opening state to the closing state through the rotation of the upper casing 10 with respect to the lower casing 11.

An internal face of the upper casing 10 (a face on a side facing the lower casing 11) is provided with a display 13 for displaying an input character or image, an address book and a transmitted/received mail and a speaker 14 for outputting a voice. Although the display 13 and the speaker 14 are covered with the lower casing 11 and are not exposed to an outside in the state in which the mobile phone 1 is closed, they are exposed to the outside when the upper casing 10 is rotated with respect to the lower casing 11 and is thus deformed into the opening state.

An internal face of the lower casing 11 (a face on a side facing the upper casing 10) is provided with an operation key 15 such as a cross key for moving a cursor vertically and transversely, a numeric key for inputting a numeral and a transmission key for carrying out a transmission processing, for example. Moreover, the lower casing 11 is provided with a microphone 16 for collecting a voice. Although the operation key 15 and the microphone 16 are covered with the upper casing 10 and are not exposed to the outside when the mobile phone 1 is set as the closing state, they are exposed to the outside when the upper casing 10 is rotated with respect to the lower casing 11 and is thus deformed into the opening state.

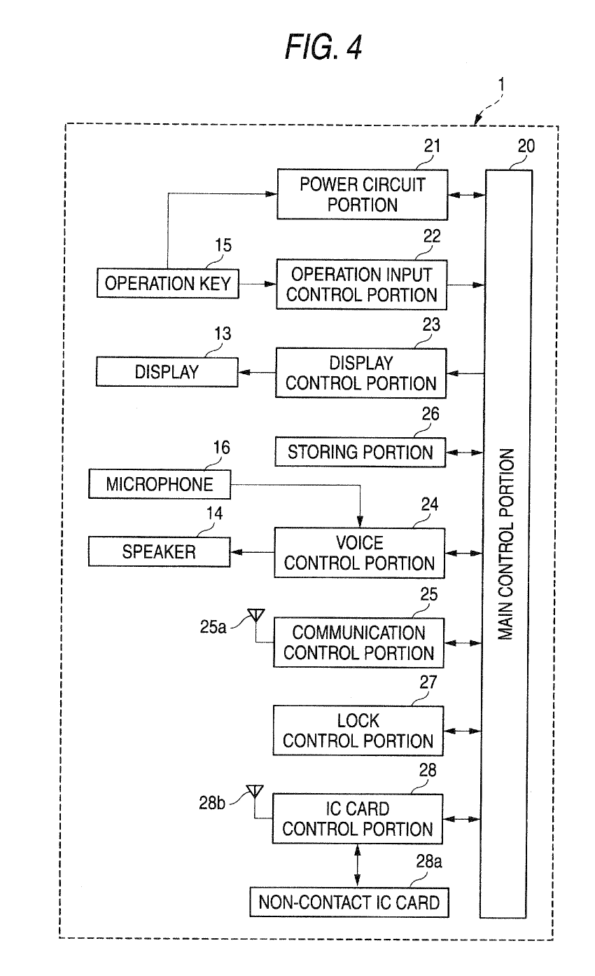

Next, the function of the mobile phone 1 will be described with reference to a functional block diagram of FIG. 4. As shown in FIG. 4, the mobile phone 1 has a structure in which a main control portion 20, a power circuit portion 21, an operation input control portion 22, a display control portion 23, a voice control portion 24, a communication control portion 25, a storing portion 26, a lock control portion 27 and an IC card control portion 28 are mutually connected through a bus.

The main control portion 20 includes a Central Processing Unit (CPU) and serves to carry out a general control for the mobile phone 1, and furthermore, to execute a setting processing and a no-service lock processing which will be described below, and other various calculation processing and control processing. The power circuit portion 21 switches the ON/OFF state of a power source based on an input at the operation key 15 by a user and feeds a power from a power supply source (a battery) to each portion when the power source is ON, thereby causing the mobile phone 1 to be operable.

The operation input control portion 22 includes an input interface for the operation key 15 and transmits a signal input at the operation key 15 to the main control portion 20. The display control portion 23 includes a display interface for the display 13 and displays document information and image information on the display 13 based on a control of the main control portion 20.

The voice control portion 24 generates an analog audio signal from a voice collected through the microphone 16 based on the control of the main control portion 20 and converts the analog audio signal into a digital audio signal. Moreover, the voice control portion 24 converts the digital audio signal into the analog audio signal and outputs a voice from the speaker 14 based on the control of the main control portion 20 when acquiring the digital audio signal.

The communication control portion 25 carries out a spectrum de-spreading processing over a signal received from the base station 2 through an antenna 25a and decompresses data based on the control of the main control portion 20. The data are transmitted to the voice control portion 24 and are output from the speaker 14, are transmitted to the display control portion 23 and are displayed on the display 13, or are recorded in the storing portion 26 in accordance with an instruction given from the main control portion 20. When acquiring the voice data collected through the microphone 16, the data input at the operation key 15 or the data stored in the storing portion 26 based on the control of the main control portion 20, moreover, the communication control portion 25 carries out a spectrum spreading processing over the data and transmits the data thus obtained to the base station 2 through the antenna 25a.

Furthermore, the communication control portion 25 generates information indicating a receiving sensitivity of a radio wave received by the antenna 25a and transmits the information to the main control portion 20 based on the control of the main control portion 20. The main control portion 20 determines whether the mobile phone 1 is in a coverage area or out of service based on the information.

The storing portion 26 is configured of a Read Only Memory (ROM), a hard disk, a nonvolatile memory and a database which store processing programs and data required for a processing to be carried out by the main control portion 20, and a Random Access Memory (RAM) for temporarily storing data to be used when the main control portion 20 carries out the processing. Moreover, it is assumed that processing programs for the main control portion 20 to execute a setting processing and a no-service lock processing which will be described below are stored in the ROM, for example.

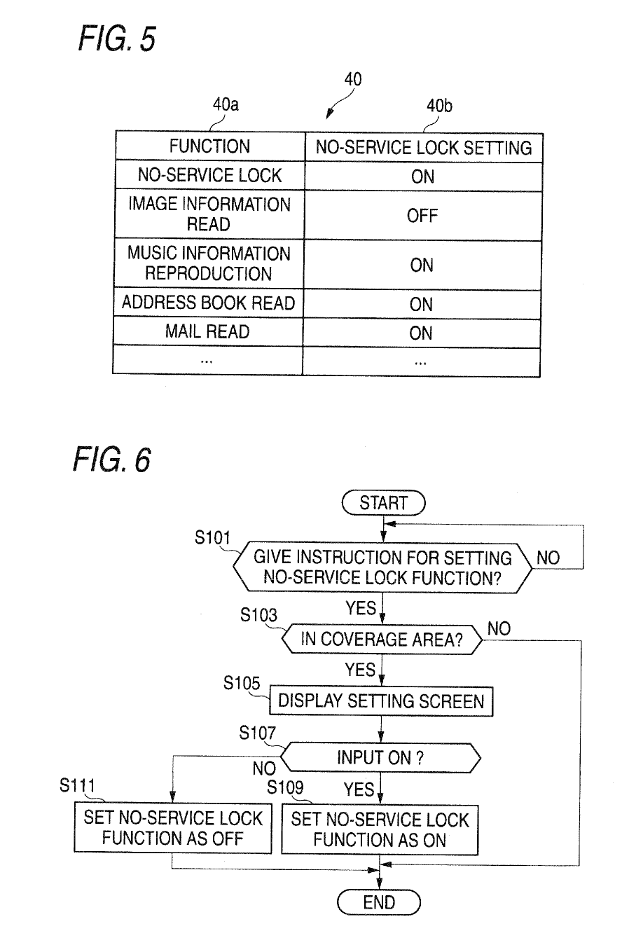

Furthermore, the storing portion 26 stores no-service lock setting information 40 for causing the mobile phone 1 to execute the no-service lock processing. Referring to the no-service lock setting information 40, it is set whether a no-service lock is applied to each function when the mobile phone 1 is out of service, and function information 40a indicating a function and lock information 40b indicating whether the no-service lock is applied are caused to correspond to each other as shown in FIG. 5. In the lock information 40b, the case in which the no-service lock is applied is set as “ON” and the case in which the no-service lock is not applied is set as “OFF”, for example.

For example, in the no-service lock setting information 40 shown in FIG. 5, the no-service lock information 40b of “ON” corresponds to the function information 40a of “no-service lock”. This implies that the no-service lock function is used when the mobile phone 1 is out of service. In the case in which a user previously recognizes that the mobile phone 1 might be out of service when moving to an underground or taking a trip, for example, it is also possible to use the mobile phone 1 in an area out of service by setting the no-service lock function as “OFF”. The setting can be carried out only when the mobile phone 1 is in a coverage area. Because it is impossible to reliably protect personal information and a non-contact IC function when the no-service lock function can also be turned “OFF” in a no-service state.

In the no-service lock setting information 40 shown in FIG. 5, moreover, the no-service lock information 40b of “OFF”, the no-service lock information 40b of “ON”, the no-service lock information 40b of “ON” and the no-service lock information 40b of “ON” correspond to the function information 40a of “image information read”, the function information 40a of “music information reproduction”, the function information 40a of “address book read”, and the function information 40a of “mail read”, respectively. This implies that the no-service lock is not carried out for the image information reading function and is carried out for the music information reproducing, address book reading and mail reading functions when the mobile phone 1 is out of service.

In addition, it is possible to propose, as a function to which the no-service lock is to be applied, the unauthorized use of the non-contact IC card function and the read of personal information such as moving picture information and schedule information which are stored in the storing portion 26 and book mark information to be used for Web read. Moreover, the method of setting “ON” or “OFF” every function is not restricted but the no-service lock may be applied to all of the functions when the no-service lock is set as “ON”.

Although the ON/OFF state of the no-service lock function is preset by the user, the setting can be carried out only when the mobile phone 1 is in a coverage area. The reason is as follows. In the case in which the mobile phone 1 is out of service and the remote lock cannot be applied when the user loses the mobile phone 1, a third party cannot change the no-service lock setting iniquitously. Also in the case in which the third party moves to a coverage area in order to iniquitously unlock the no-service lock function of the mobile phone 1, the mobile phone 1 is locked by remote lock in a timing when the mobile phone 1 returns to the coverage area so that the no-service lock function cannot be unlocked.

In the case in which the user wants to utilize the personal information and the non-contact IC card function in the mobile phone 1 when the mobile phone 1 is out of service, however, the user-friendliness gets worse if the mobile phone 1 is locked. By employing a structure in which the no-service lock function can be set as “OFF” when the mobile phone 1 is in a coverage area, accordingly, the user presets the no-service lock function as “OFF” and can thus utilize the personal information and the non-contact IC card function in the mobile phone 1 even if the mobile phone 1 is out of service.

The lock control portion 27 locks each function to prohibit the utilization and carries out unlocking to permit the utilization based on the ON/OFF state of the no-service lock setting information 40 stored in the storing portion 26 through the control of the main control portion 20. In the case in which the communication control portion 25 receives a signal for remotely locking the mobile phone 1 from the base station 2, moreover, the lock control portion 27 locks each function of the mobile phone 1 to prohibit access to the information stored in the storing portion 26 and to prohibit the use of each function provided in the mobile phone 1.

The IC card control portion 28 includes a non-contact IC card 28a and an antenna 28b, and carries out a communication control for a reader and a writer in the non-contact IC card 28a through the antenna 28b. More specifically, the IC card control portion 28 transmits information stored in the non-contact IC card 28a to a reader and a writer of the non-contact IC card 28a through the antenna 28b and stores the information received from the reader and the writer through the antenna 28b in the non-contact IC card 28a, and thus inputs/outputs information to/from the non-contact IC card 28a based on an instruction given from the main control portion 20.

When setting the no-service lock setting information 40, the user inputs the ON/OFF state of the no-service lock related to each function at the operation key 15. The mobile phone 1 carries out a setting processing of setting the ON/OFF state of the no-service lock related to each function input by the user, thereby storing the ON/OFF state as the no-service lock setting information 40 in the storing portion 26. A procedure for causing the mobile phone 1 to carry out the setting processing will be described with reference to a flowchart of FIG. 6. For example, “Step S101” will be hereinafter referred to as “S101” with an omission of “Step” and the description will be thus given.

When setting the no-service lock function by using the mobile phone 1, the user first gives an instruction for setting no-service lock at the operation key 15. First of all, the main control portion 20 determines whether an instruction for setting the no-service lock function is given or not (S101). If the instruction for setting the no-service lock is not given (No in S101), the main control portion 20 remains waiting.

If the instruction for setting the no-service lock is given (Yes in S101), the main control portion 20 determines whether the mobile phone 1 is in a coverage area or not (S103). In this case, the main control portion 20 acquires information indicating a receiving sensitivity of a radio wave from the communication control portion 25 and determines whether the mobile phone 1 is in a coverage area or out of service based thereon. If the mobile phone 1 is out of service (No in S103), the main control portion 20 does not set the no-service lock but ends the setting processing.

If the mobile phone 1 is in a coverage area (Yes in S103), the main control portion 20 displays a setting screen of the no-service lock on the display 13 (S105). The setting screen has an input column for inputting “ON” or “OFF” for each function, for example, and the user inputs “ON” or “OFF” in each input column at the operation key 15.

The main control portion 20 determines whether “ON” is input or not (S107). If “ON” is input (Yes in S107), the main control portion 20 associates the function information 40a of the function with the lock information 40b of “ON” and sets the no-service lock of the function as ON (S109). If “OFF” is input (No in S107), the main control portion 20 associates the function information 40a of the function with the lock information 40b of “OFF” and sets the no-service lock of the function as “OFF” (S111).

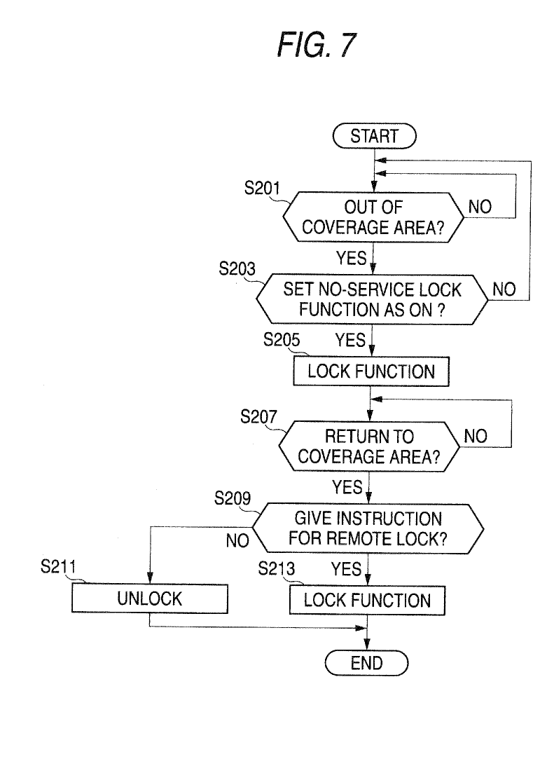

Thus, the mobile phone 1 stores the input information as the no-service lock setting information 40 when “ON” or “OFF” is input to each function through the user. Then, the mobile phone 1 carries out a no-service lock processing of locking each function in the no-service of the mobile phone 1 based on the no-service lock setting information 40. A procedure for causing the mobile phone 1 to carry out the no-service lock processing will be described with reference to a flowchart of FIG. 7.

First of all, the main control portion 20 determines whether the mobile phone 1 is out of service or not (S201). In this case, the main control portion 20 acquires information indicating a receiving sensitivity of a radio wave from the communication control portion 25 and determines whether the mobile phone 1 is out of service or not based on the information. If the mobile phone 1 is not out of service (No in S201), that is, the mobile phone 1 is in a coverage area, it is not necessary to apply the no-service lock to the mobile phone 1. Therefore, the main control portion 20 remains waiting.

If the mobile phone 1 is out of service (Yes in S201), the main control portion 20 determines whether the no-service lock function is set as ON or not (S203). In this case, the main control portion 20 acquires the no-service lock setting information 40 from the storing portion 26 and determines that the no-service lock function is set as ON if the lock information 40b corresponding to the function information 40a of “no-service lock” is set as “ON”.

If the no-service lock function is set as “OFF” (No in S203), it is not necessary to apply the no-service lock to the mobile phone 1. Returning to the Step S201, therefore, the main control portion 20 determines whether the mobile phone 1 is out of service or not. For example, in the case in which the user moves to an underground or takes a trip, there is a possibility that each function of the mobile phone 1 cannot be used if the no-service lock is applied. For this reason, it can also be supposed that the no-service lock function is set as “OFF”. If the no-service lock function is set as “OFF”, therefore, the no-service lock is not carried out.

If the no-service lock function is set as “ON”, the main control portion 20 locks all of the functions in which the lock information 40b is set as “ON” and prohibits the utilization (S205). Consequently, the no-service lock is applied to the mobile phone 1. Referring to the no-service lock setting information 40 shown in FIG. 5, for example, the functions of the music information reproduction, the address book read and the mail read are locked.

The main control portion 20 determines whether the mobile phone 1 returns to the coverage area or not (S207). In this case, the main control portion 20 acquires the information indicating the receiving sensitivity of the radio wave from the communication control portion 25 and determines whether the mobile phone 1 returns to the area out of service or not based on the information. If the mobile phone 1 does not return to the coverage area (No in S207), the processing returns to the Step S207 in which the main control portion 20 stands by until the mobile phone 1 returns to the coverage area.

If the mobile phone 1 returns to the coverage area (Yes in S207), the main control portion 20 determines whether an instruction for remote lock is given to the mobile phone 1 or not (S209). The remote lock is a function for remotely applying locking by communicating with the mobile phone 1 based on the communication of the user with a company for the mobile phone 1.

If the instruction for remote lock is not given (No in S209), the main control portion 20 unlocks the no-service lock applied at the Step S205 (S211). If the instruction for remote lock is given (Yes in S209), moreover, the main control portion 20 locks the mobile phone 1 (S213).

If the user holds the mobile phone 1 without losing it, the no-service lock is unlocked in a timing in which the mobile phone 1 returns to the coverage area so that the user can utilize the mobile phone 1. If the user loses the mobile phone 1 and communicates with the company for the mobile phone 1 to apply the remote lock, the remote lock is applied to the mobile phone 1 by a remote control in the timing in which the mobile phone 1 returns to the coverage area and the mobile phone 1 can be prevented from being iniquitously used by a third person.

Thus, the mobile phone 1 determines the no-service lock setting state based on the no-service lock setting information 40. When the no-service lock function is set as “ON”, the no-service lock is applied to the mobile phone 1 if the mobile phone 1 is out of service. Moreover, in the case in which the no-service lock is applied to the mobile phone 1 and the mobile phone 1 is then moved to the coverage area, the no-service lock is unlocked.

When the user loses the mobile phone 1, the personal information and the non-contact IC card function are remotely locked by the remote control in a company service if the mobile phone 1 is in a coverage area. Therefore, it is possible to prevent the unauthorized use or the leakage of information of the mobile phone 1 from being carried out by a finder. Moreover, if the user loses the mobile phone 1 and the mobile phone 1 is out of service, the unauthorized utilization and the leakage of information of the mobile phone 1 can be prevented by the no-service lock function which is preset by the user while the mobile phone 1 is in a coverage area.

The no-service lock function is controlled in software. Therefore, it is possible to prevent an increase in a cost due to an addition of hardware, an increase in a size of the apparatus due to the addition of hardware, a feeling of use for the user, and a deterioration in a convenience in the mobile phone 1. In a method of carrying out password locking in software in the no-service, moreover, there is a danger that unlocking might be carried out by a random input.

According to the mobile communication apparatus (the mobile phone 1) in accordance with the invention, the user sets the no-service lock function as “ON” in the no-service lock setting information 40. Also in the case in which the mobile phone 1 is out of service and remote lock cannot be set while the mobile phone 1 is lost, consequently, the user can apply the lock easily and reliably in such a manner that access to personal information, the use of the non-contact IC card function and access from PC to information cannot be carried out.

According to the mobile communication apparatus (the mobile phone 1) in accordance with the invention, moreover, in the case in which the user previously knows that the mobile phone 1 is moved to the no-service area, the no-service lock function is preset as “OFF” in the no-service lock setting information 40. Consequently, the user can easily carry out the unlocking in such a manner that the access to the personal information, the use of the non-contact IC card function and the access from the PC to the information can be carried out. Furthermore, by employing a mechanism capable of carrying out “ON” setting in the area out of service only in the case in which the no-service lock is set as “OFF”, it is possible to carry out the no-service lock without returning to the coverage area after using the function in the area out of service. Therefore, it is also possible to provide a more secure mobile communication apparatus.

Although the mobile phone 1 has been described in the embodiment, this is not restricted but it is also possible to employ an any mobile communication apparatuses having a remote lock function, for example, a Personal Handy phone System (PHS) or a Personal Digital Assistants (PDA).

What is claimed is:

1. A mobile communication apparatus comprising:
a remote lock function configured to lock the apparatus when receiving certain information;
a determining section configured to determine whether the apparatus is in a coverage area or not; and
a no-service lock function configured to lock the apparatus when the determining section determines that the apparatus is out of service.

2. The apparatus according to claim 1, wherein the no-service lock function unlocks the apparatus which is locked by the no-service lock function when the determining section determines that the apparatus is not out of service.

3. The apparatus according to claim 1 further comprising an accepting section configured to accept an input when the determining section determines that the apparatus is in a coverage area, the input instructing the no-service lock function to set as ON/OFF state,
wherein the no-service lock function is set as ON when the input instructing ON is accepted by the accepting section and the no-service lock function is set as OFF when the input instructing OFF is accepted by the accepting section.

4. The apparatus according to claim 1 further comprising a storing section configured to store data,
wherein the no-service lock function prohibits access to the data when the no-service lock function locks the apparatus.

5. The apparatus according to claim 1 further comprising:
a non-contact IC card;
an input/output section configured to input/output data to/from the non-contact IC card;
wherein the no-service lock function prohibits the input/output section from inputting/outputting the data to/from the non-contact IC card when the no-service lock function locks the apparatus.
